(19) United States
(12) Patent Application Publication
(10) Pub. No.: US 2002/0087382 A1
(43) Pub. Date: Jul. 4, 2002

(54) Method and system for assigning and tracking tasks, such as under an electronic auction

(76) Inventor: Vincio B. Tiburcio, Kennesaw, GA (US)

Correspondence Address: PERKINS COIE LLP, PATENT-SEA, P.O. BOX 1247, SEATTLE, WA, 98111-1247, US

(21) Appl. No.: 09/754,023

(22) Filed: Jan. 3, 2001

(51) Int. Cl. G06F 17/60

(52) U.S. Cl. 705/9; 705/37

(57) ABSTRACT

A system for assigning and managing tasks for individuals within an organization who are working together on a larger project, such as an electronic auction. Under this embodiment, once the need to procure an item (or service) is identified, an electronic auction is scheduled, and a request for quotations (RFQ) is generated. The system automatically assigns tasks to individuals within the organization to fulfill before a scheduled auction date. Alternatively, or additionally, the system permits one or more users or individuals to manually assign tasks to others within the organization. The system may track due dates and provide notifications, including periodic reminders.

### TECHNICAL FIELD

The disclosure relates generally to task assignment and tracking.

### BACKGROUND AND SUMMARY

Many businesses, particularly those in the manufacturing industries, wish to obtain raw materials and parts at the lowest possible price, while ensuring quality, timely delivery and other factors important to the business. The requisitioning process for procuring materials or goods has often been a labor-intensive, inefficient and non-standardized process. In general, a buyer must first decide what he or she must buy; second, identify sources for the items to be purchased; and third, identify what must be performed to qualify a source or item supplied by the sources.

FIGS. 1A and 1B show an example of a typical requisitioning process 100. Beginning in block 102, a buyer identifies something that needs to be purchased and when it must be delivered. In block 104, the buyer determines whether a purchasing contract is in place for the item. If so, then in block 106, the existing purchasing contract is employed. If not, then in block 108 the buyer identifies one or more suppliers capable of supplying the item. In block 110, if the buyer is not approved, then in block 112, the buyer must be preapproved, such as by executing a secrecy agreement.

In addition to identifying suppliers, the buyer must prepare an RFQ. An RFQ, or “Request For Quotations,” contains information suppliers need to prepare a bid or quotation. The RFQ likely also includes information or details regarding aspects of the item to be purchased that are important or critical to the buyer. (While RFQs are described, the description applies equally to requests for proposals (“RFPs”) and related documents generated by one party and distributed to multiple parties to obtain a preferred or best response (in the eyes of the preparer) under a generally competitive process.) Typically, the RFQ is not reviewed for completeness, and is often used only for domestic suppliers. Thus, certain additional information is not required, such as export control licenses and the like. The identified suppliers (previously approved, or approved under block 112) receive the RFQ, such as by mail or email, under block 116. In block 118, the business receives technical proposals and proposed deviations or exceptions to the RFQ from one or more suppliers. The buyer or other evaluator can determine whether the product or item proposed by a supplier is acceptable for the buyer's intended application. If not, the supplier may not be permitted to participate.

In block 120, bids begin to trickle in from the suppliers, and all bids are considered received by some cutoff point (under block 122). In block 124, the buyer negotiates with one or more suppliers based on the received bids, and in block 126 determines a supplier from whom to purchase the desired item. In block 128, the buyer provides oral or written feedback to the suppliers identifying, for example, the supplier selected and possible reasons for the selection.

Under block 130, if the item purchased requires qualification, then in block 132, a qualification plan is defined by either the buyer, a quality assurance individual, or some other person. In block 134, the buyer or other individual requests samples from the supplier in order to execute the qualification plan. In block 136, the qualification plan is executed and the purchased items are tested. If the items do not qualify under block 138, then in block 140 it is determined whether time exists to retest the items. If so, the process loops back to block 136, and if not, the buyer may renegotiate with the supplier or one or more other qualified suppliers, under block 142. If the samples passed qualification testing, and the vendor does not have a vendor number under block 144, the buyer or other individual obtain a supplier or vendor number in block 146. Following blocks 130, 142, 144 or 146, “Material Requisition Planning” or “Manufacturing Resource Planning” (“MRP”) or purchasing system data is updated, such as to include a vendor number under block 148, and in block 150, the MRP system automatically generates one or more purchase orders to purchase the required items.

An MRP system is a system by which purchasing contracts are planned based on the need date of the purchased item. For “direct material” (i.e., purchased material that is incorporated directly into a product to be sold), the MRP system employs or calculates a quantity of an item required based on sales that incorporate that purchased item. For “indirect material” (i.e., purchased material that is consumed rather than converted into a sold product), the MRP system employs or calculates the appropriate reorder time/amount based on stock-on-hand and consumption rate. The MRP system contains complete supplier and product information, such as the most recent quotes, preferred vendor identification and the like. MRP systems are well-known in the art, and employ automated software tools to perform such processes, automatically generating purchase orders as required to purchase items the system forecasts will be needed by the anticipated delivery date of such items.

There are many bottlenecks in the process described above. Examples of such bottlenecks are indicated by ovals within FIGS. 1A and 1B. Most bottlenecks occur because manual processes and the need to communicate between individuals within an organization. For example, preparing an RFQ was a lengthy, manual process that often required considerable manual manipulation of documents and spreadsheets to fit many nonstandard RFQ transactions into a standard electronic template.

Buyers typically were required to coordinate with other individuals within the organization to approve new suppliers. Individuals within the organization attempting to combine orders needed to communicate so as to provide improved savings for the organization under the auction. If a technical review of a proposed item was required, the technical review team needed to coordinate and provide results to the buyer before the auction. Likewise, qualification testing may often have been required after the auction. If no MRP system existed, then purchase orders must be manually generated.

Previous approaches to coordinate an auction involved sharing electronically generated spreadsheets, such as by electronic mail. Numerous electronic mail messages and telephone calls between individuals within the organization were required to coordinate document preparation and review for each auction. Where possible, electronic calendars were reviewed to ensure appropriate availability of individuals for associated tasks with respect to the auction. The process left many opportunities for insufficient coordination and miscommunicated auction dates. Another drawback may be that suppliers were not informed of correct auction dates, or appropriate individuals had not approved the auction before it was executed.

Another problem with prior requisitioning systems was that they typically were inefficient at managing high-volume activities, incapable of handling high-speed negotiations, incapable of purchasing foreign-manufactured goods, unable to leverage across business units, ineffective with communications and transactions, fraught with time-zone problems and/or other problems. For example, an RFQ may have been provided to suppliers without providing the suppliers with corresponding adequate preparation time. In general, bottlenecks occur in generating and distributing the RFQ (e.g., gathering and including drawings and pictures, identifying leveraging opportunities), obtaining vendor numbers, updating MRP or purchasing systems, etc.

As noted above, prior art attempts to automate the requisitioning process included using email. However, email often has limitations in sending large electronic documents. Further, many steps in the process described above are manual. The inventors have found that using a public computer network, such as the Internet, may be employed to improve efficiency.

The Internet is increasingly being used to conduct “electronic commerce.” The Internet comprises a vast number of computers and computer networks interconnected through communications channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction.

The World Wide Web portion of the Internet is especially conducive to conducting electronic commerce. Many web servers have been developed through which vendors can sell items. Generally, an “item” is any product, service, or exchangeable entity of any type. A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming web page to the client computer system and schedules shipment of the items.

The World Wide Web is also being used to conduct other types of commercial transactions. For example, some server computer systems have been developed to support conducting auctions electronically. To conduct an auction electronically, the seller of an item provides a definition of the auction via web pages to a server computer system. The definition includes a description of the item, an auction time period, and optionally a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

A reverse auction may be preferred for procurement. A “reverse auction” is one in which the purchaser states requirements; then, suppliers who can meet the stated requirements compete for the business by offering the lowest price, quickest delivery, or whatever other conditions are sought by the purchaser. It is “reverse” because the usual competitive factor is price, and unlike a typical auction (“forward auction”), price goes down as the auction progresses.

Described in detail below is a method and system to improve assigning and managing personnel tasks under large projects, such as for electronic auctions.

### BRIEF DESCRIPTION OF THE DRAWINGS

FIGS. 1A and 1B together form a flow diagram illustrating an example of a prior art procurement process, which illustrates many manual processes.

FIG. 2 shows an example of a user's home page computer screen.

FIG. 3 is an example of a Create New Auction screen.

FIG. 4 is an example of an auction setup screen, which includes fields for assigning tasks to individuals within the organization.

FIG. 5 is a flow diagram illustrating an example of a task assignment and management method.

FIG. 6 is a block diagram illustrating a suitable hardware environment for implementing aspects of the invention.

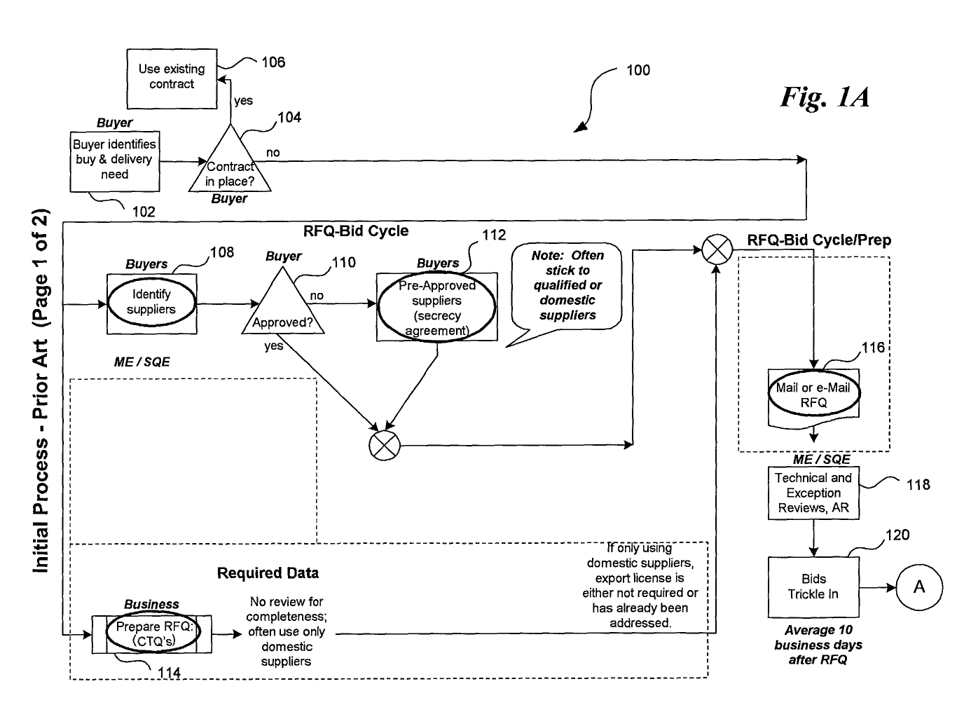

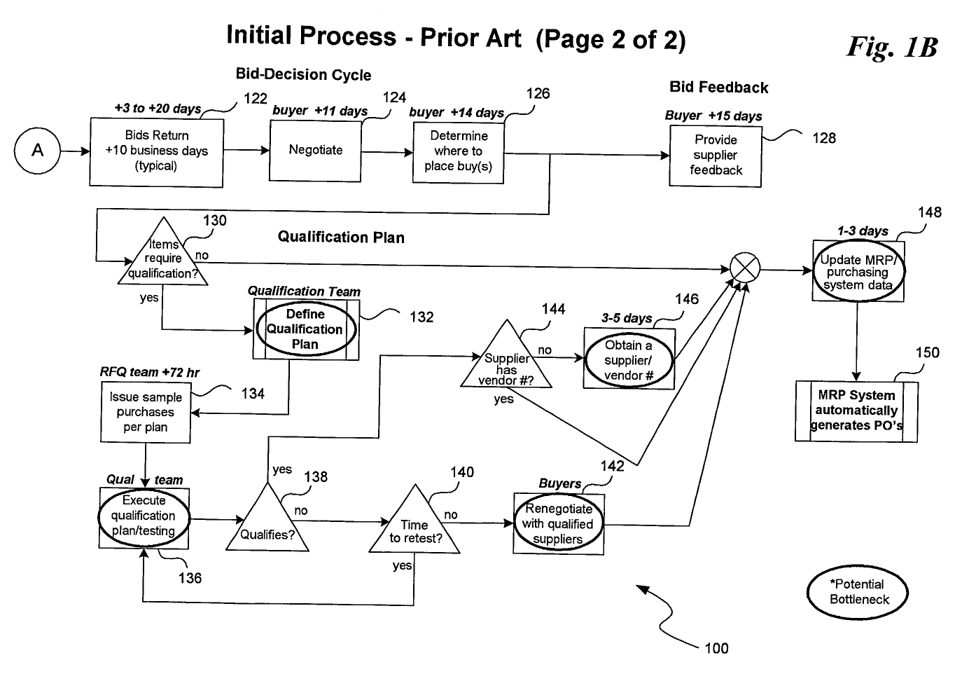

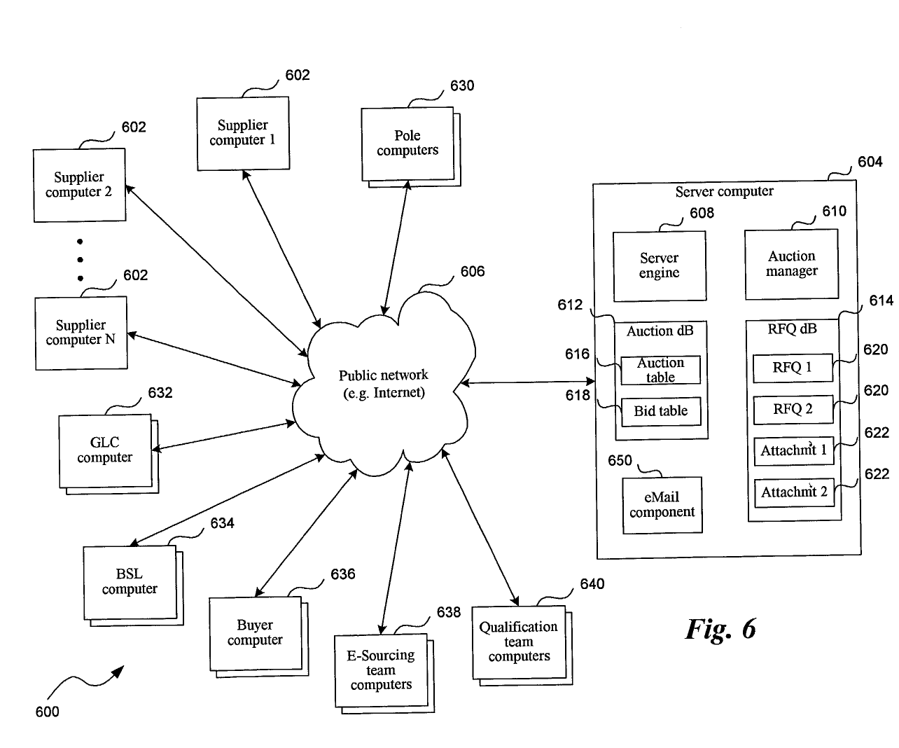

In the drawings, identical reference numbers identify identical or substantially similar elements or acts. To easily identify the discussion of any particular element or act, the most significant digit or digits in a reference number refer to the Figure number in which that element is first introduced (e.g., block 604 is first introduced and discussed with respect to FIG. 6).

The headings provided herein are for convenience only, and do not affect the scope or meaning of the claimed invention.

### DETAILED DESCRIPTION

A process for assigning and managing tasks such as for assigning different personnel tasks in electronic auctions, is described in detail below. In the following description, numerous specific details are provided, such as specific data fields and forms, ordering of processes, necessary input fields, and the like, to provide a thorough understanding of, and enabling description for, embodiments of the invention. One skilled in the relevant art, however, will recognize that the invention can be practiced without one or more of the specific details, or with other fields, forms or processes, etc. In other instances, well-known structures or operations are not shown, or are not described in detail, to avoid obscuring aspects of the invention.

In general, the process and system described in detail herein provides a computer network based task management tool that enables users or buyers to create new auctions and assign tasks to appropriate individuals within the organization based on the auction. The system provides an interface and tool, such as a web-based electronic tool, to ensure appropriate communication of pending auctions and scheduled auction events to all auction support personnel. The task management tool encompasses international standards organization (“ISO”) procedures of distinct business units within the organization, so that the auction process does not violate any existing ISO procedures. The tool expedites documentation completion and approval by sending task reminders and potentially invoking automatic suspension or approval. The tool assigns milestone tasks, including notifying appropriate individuals that an auction is proposed (such as pole personnel, global commodity leader, and business sourcing leader), notifying an auction owner that an RFQ is pending completion, and notifying auction support personnel that other tasks are due, as described herein. The tool invokes processes to require the auction owner to approve suppliers to participate in an auction, requiring quality monitoring/assurance individuals to approve a supplier to participate based on a previously executed secrecy and/or intellectual property protection agreement executed by the supplier, requiring the business sourcing and global commodity leaders to approve the auction before scheduling, requiring parties to complete any required fields within an RFQ, and requiring pole personnel to participate in the auction, as described below. The tool assigns default due dates for auctions, but allows the auction owner to change such defaults. Furthermore, the tool ensures sufficient time exists to complete existing tasks and notify support auction personnel of a approval schedule before the proposed auction date. To aid in task execution, the system stores all documentation to be reviewed, including an auction schedule, at a central site such as on a single web server.

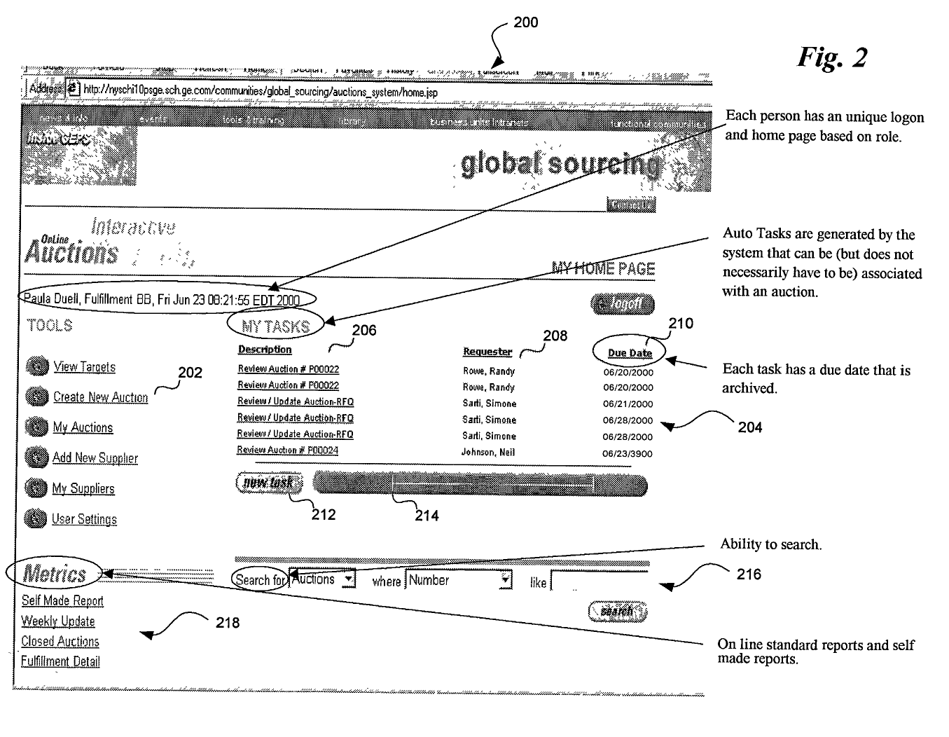

Referring to FIGS. 2 through 4, representative computer displays or web pages will now be described with respect to assigning and managing tasks, such as for use with an electronic auction. The web pages may be implemented in XML (Extensible Markup Language) or HTML (HyperText Markup Language) scripts that provide information to a user. The web pages provide facilities to receive input data, such as in the form of fields of a form to be filled in, pull-down menus or entries allowing one or more of several entries to be selected, buttons, sliders, or other known user interface tools for receiving user input in a web page. Of course, while one or more ways of displaying information to users in pages are shown and described herein, those skilled in the relevant art will recognize that various other alternatives may be employed. The terms “screen,” “web page” and “page” are generally used interchangeably herein. While XML and HTML are described, various other methods of creating displayable data may be employed, such as the Wireless Access Protocol (“WAP”).

The Web pages are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locater identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), matrix or bitmapped formats. All aspects of the invention are described herein using a networked environment, some or all features may be implemented within a single-computer environment.

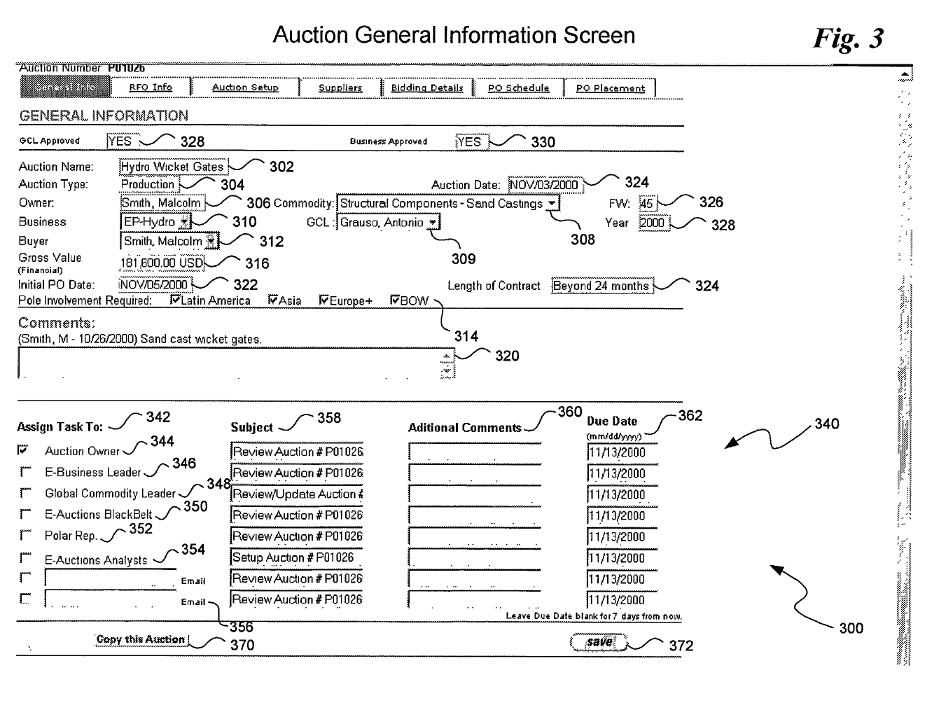

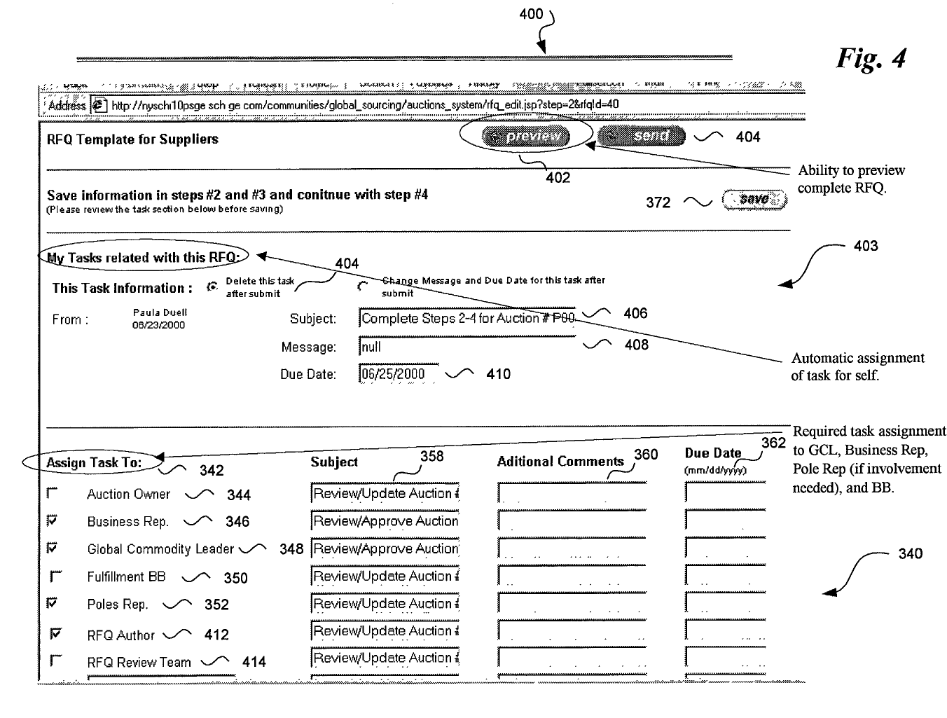

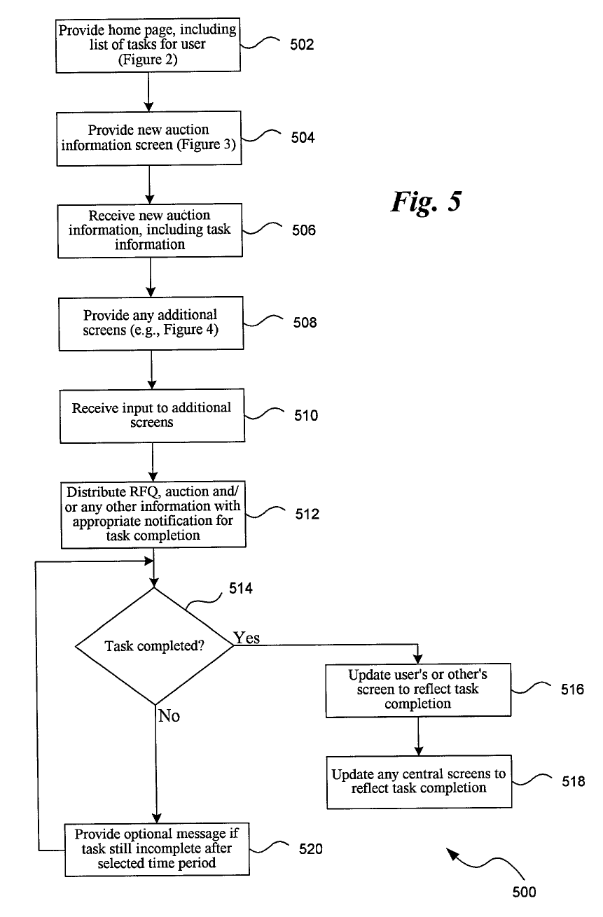

Referring to FIG. 2, a suitable, customized home page 200 is shown for a user of the system (in this example, “Paula Duell”). The home page 200 includes a Create New Auction link 202, which if selected by a user, causes retrieval and display of an appropriate Create New Auction screen, such as a web page 300 shown in FIG. 3. A My Tasks section 204 includes a listing of tasks associated with the user. Each task is listed in a separate row, with three information columns provided: a description column 206 providing a brief description of the auction (and/or associated tasks), a requester column 208 identifying the person who requested the task, and a due date column identifying when the task is due. Due dates may be in different colors, depending on whether the task has been completed. For example, pending due dates may be in solid or bright colors, while completed tasks may be depicted with a due data in gray or dull colors.

A new task button 212 allows the user to assign a new task to him or herself, or other individuals within the organization. A slider bar 214 allows the user to scroll within a large list of tasks (which is unnecessary in the example of FIG. 2 having only six tasks).

A search section 216 allows the user to search for auctions or other events based on a number or title or other field. Metrics section 218 allows the user to create or update reports regarding tracking of procurement auction activities, and gauge how progress toward fulfilling business goals is being achieved.

The My Tasks section 204 may also include an auction number column (not shown) that lists an auction number associated with a given auction (as opposed to including it in the Description column 206). While not shown, the screen 200 may also include a User's Manual hypertext link that links to one or more pages providing instructions for the author in completing this and other web pages. Additionally, a Glossary link may link to a glossary defining terms used in the screens.

Referring to FIG. 3, the Create New Auction page 300 is shown in greater detail. As shown in FIG. 3, the Create New Auction page includes an Auction Name field 302 for the user to assign an alpha-numeric name to be used for the auction, such as the name of the commodity to be purchased. An Auction Type field 304 includes a pull-down menu of auction types, such as “Production” or “Qualification,” A “production auction,” as generally used herein, refers to an auction where no qualifications are necessary for suppliers. Alternatively, a “qualification auction,” typically refers to an auction where the items offered by unqualified suppliers must be qualified. Other auction types include “Forward,” “Reverse,” and “Reverse-Sealed.” Under one embodiment, the default is “Reverse.” In general, the default values described herein are with respect to the depicted embodiment; those skilled in the relevant art will readily recognize that other default values may be selected. A “Sealed” auction, as generally used herein, refers to an auction where bids or other information provided by suppliers is not shared or made available to other suppliers.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

In an Owner field 306, the system may automatically enter the user currently filling in the web page or “author” (in this example, Malcolm Smith). A Commodity field 308 provides a pull-down menu of commodities purchased by the business organization. Examples of such commodities include: machinings; fabrications; mechanical and fluid systems; castings; forgings; piping; balance of plant; electrical; combustion; Maintenance, Repair and Operations (“MRO”) items; chemicals; facilities; utilities; environmental health and safety (“EHS”); logistics; capital expenditures; tooling/fixtures; engineering surfaces; software; contract services; and office technology (all with respect to, for example, a power systems manufacturer). By selecting one of the commodities from the pull-down menu, additional fields within this and other web pages are set as defaults, such as a default GCL (in field 309) and commodity black belt. In other words, the Commodity field is linked with other fields within the web page forms. Thus, selecting one commodity from the pull-down menu automatically selects an associated GCL for that commodity. Other fields are similarly linked, as described herein.

A “Global Commodity Leader” (“GCL”) has the responsibility to be a single commodity expert across an entire business (across distinct profit and loss centers). The GCL strategizes where and how to purchase, how to leverage volume, and how to split purchases to best utilize or manage an available supply base. The GCL may work for a sourcing functional manager, rather than directly for production within the organization. As indicated by their title, GCLs are expected to be familiar with the entire world's supply capability and price structure for their particular commodities. GCLs rely upon buyers to actually purchase items and ensure delivery.

In one embodiment, the GCL may consider cross-business initiatives. “Cross-business,” as generally used herein, refers to sharing information for grouping purchased volumes of items for the sake of better negotiation with suppliers. Cross-business refers to collaboration between business units with each having different organizational structures and distinct operational objectives. For example, a large organization having an aircraft engine business and an industrial systems business may have totally different operations, but the businesses may be able to collaboratively buy common items such as hand tools or small batteries under leadership of the GCL. In general, while the processes are generally described herein for procuring items, the process may also be performed for procuring services to be performed. A “separate business unit” or “business unit,” as generally used herein, refers to a separate profit and loss center or group within a larger business organization.

A commodity “black belt” (“BB”), as generally used herein, refers to individuals within the business organization that characterize and optimize key processes that exert undue influence on the business landscape. They identify and execute projects that will reduce errors and defects in industrial and commercial processes, and in products and services (e.g., reduce labor, material, cycle time and inventory). Further information regarding black belts may be found in M. Harry and R. Schroeder, Six Sigma, Breakthrough Management Strategy Revolutioning the World's Top Corporations (Currency Press, 2000).

A Business field 310 includes a pull-down menu of all business units associated with the business organization, such as “Energy Products-Gas,” “Energy Products-Steam,” etc. As a default, the system may populate the Business field with the author's associated business unit (from the owner field 306). Not only business units, but specific sites for such units may be provided for the business field to permit a lowest possible level for tracking and statistical metric generation.

A Buyer field 312 provides a pull-down menu listing in alphabetical order all global buyers within the organization, such as in the format of “last name, first name.” The Buyer field may be linked to the Business field 310 (and other fields, such as an e-business leader field, described below). A “buyer” as generally used herein, refers to an individual or group chiefly responsible for maintaining work flow by contracting for and ensuring delivery of purchased items or services. Buyers are typically very familiar with a finite scope of purchased items, established suppliers of those items, and the logistics and timing issues involved with procuring those items. In practice, buyers have traditionally handled negotiations for purchases; under alternative embodiments, GCLs perform some negotiations to leverage volume, share best practices, and use preferred suppliers. The buyer may often by the author of the RFQ and auction, as described herein.

A Pole Involvement Required field 314 indicates whether suppliers in various geographic poles (and corresponding pole personnel) are to be involved in the auction. As shown, examples of such geographic poles include “Latin America”, “Asia,” “Europe,” and “BOW” (balance of world), where a default selects all poles. A “pole” as generally used herein, refers to a specific region of the world targeted as having low-cost, high quality or other required supply base for items consumed by a purchasing organization. A pole may be a preferred source for particular items, such as the Asian pole for textiles and hand tools due to labor costs within such region. Within each identified pole, sourcing engineers are located. “Sourcing engineers” are personnel to identify and develop good suppliers within that region, and may be the pole personnel themselves. “Pole personnel” are generally local nationals (“polar representative”) working directly with suppliers and national commerce organizations to attract business into the geographic region, and thus work with, for example, the GCL to encourage bids under an electronic auction to suppliers within that pole.

A Gross Value field 316 allows the author to input an estimated total value for the commodity being purchased. A Comments field 320 allows the author to input comments with respect to the auction. An Auction Date field 324 allows the author to input the month, day and year for the date of the auction (or proposed date), and may include a pull-down menu for rapidly inputting the date. A fiscal week (FW) field 326 and Year field 328 identify the fiscal week and year for the auction, and may be automatically completed based on the auction date previously entered.

An initial purchase order date field 322 allows the author to enter an anticipated date that a first purchase order will be submitted to the winning supplier at the conclusion of the auction. A Length of Contract field 324 indicates how long a contract with a winning supplier will extend. A GCL Approved field 328 and a Business Approved field 330 indicate whether the GCL and appropriate business unit approve of conducting the auction, respectively.

A task assignment section 340 includes an Assign Task To section or column 342 that allows the author to assign tasks to various individuals within the business organization, such as by selecting boxes 344, 346, 348, 350, 352, and 354 for the auction owner (e.g., author), e-business leader, GCL, e-auctions black belt, pole representative and e-auctions analysts, respectively. A Business Electronic Sourcing Leader (“BSL”) or e-business leader is delegated by each business unit to migrate sourcing or requisitioning activities into more efficient electronic methods. The BSL's role, with respect to electronic auctions, is to ensure that business goals are met, such as sufficient percentage of procurement performed through electronic auctions, savings targets are established, and accomplished, and the like. The BSL may be the buyer.

An “e-auctions” or “e-sourcing team,” as generally used herein, refers to a central functional group including a webmaster and analysts whose purpose is to schedule and facilitate electronic commerce for all business units. The group ensures both buyers and suppliers have appropriate, protected access to business tools used to prepare for and conduct electronic auctions. This group maintains a help desk during auction events to assist with any technical problems, or other questions that may arise, to thereby facilitate the auction. The group ensures training of all users, both buyers and suppliers, in using the process. Furthermore, the group reports overall business metrics with respect to electronic procurement with respect to business objectives or a “business road map.”

Blank fields 356 are provided to allow the author to assign tasks to additional individuals not identified in the Assigned Task To section 342. The author simply inserts the e-mail address for the individual for whom a task is to be assigned, and as described herein, the system automatically forwards notifying e-mails to the task recipient. While two of such blank fields are provided, only one, and more than two may be provided.

A Subject section or column 358 includes fields defining the subject of the task assigned to the corresponding person under the Assigned Task To section. For example, most individuals are required to review the auction, but the GCLs also requested to update the auction, while the e-auction analysts are required to setup the auction. The system may automatically assign default tasks in the Subject section to particular individuals, but the author may edit such defaults. An Additional Comments section 360 allows the author to add additional comments associated with each person having a task, while a Due Date section 362 allows the author to input a due date for the task. The system automatically inputs a due date of seven days from the date the author completes the web page 300, but the author may change such default due dates.

In one embodiment, the system automatically assigns tasks to appropriate individuals. For example, if one or more of the Pole Involvement Fields 314 are checked, then the system may automatically check the Polar Representative box 352 and assign a review action task and 7-day due date in sections 358 and 362 respectively. As a result, the system automatically sends electronic mail to the appropriate polar representative within the various poles to notify the representative of an upcoming auction. When the RFQ is completed, the system automatically forwards the completed RFQ to the polar representatives. Likewise, based on the commodity selected under the Commodity field 308, the system automatically identifies the associated GCL for that commodity, and fills in not only the GCL field 309, but also marks the GCL box 348 and assigns tasks and due dates. Likewise, for any auction, the e-business leader and e-auctions analyst boxes 346 and 354 may automatically be selected to assign review and setup tasks for the auction, respectively.

Various other automatically assigned tasks are possible. For example, the system may automatically assign a task to the auction owner to approve suppliers who may participate in the auction. The system may determine whether any proposed suppliers have not been approved, and if so, automatically assign tasks to quality monitoring/assurance individuals, such as sourcing quality administrators or pole sourcing engineers to approve a supplier to participate (such as ensuring that the supplier executes a secrecy and/or intellectual property protection agreement, completes a self audit form, and any necessary business audits are performed (a “white paper”)). The system may automatically assign tasks to the GCL and BSL to review and approve the auction, where such review and approval must occur (if at all) relatively quickly within the auction setup process, and thus the system may assign a due date of less than seven days for such approval. The GCL or BSL, of course, may defer or extend this due date, as described herein. Furthermore, if any fields within the web page forms described herein and any other patent applications described below include mandatory fields that have yet to be completed, the system may automatically assign tasks to appropriate individuals who are required to complete such fields (such as the initial purchase order date field 322 being assigned to the buyer, and possibly the Gross Value field assigned to the GCL).

The actual tasks involved are particular to the organization and the overall project to be completed such as an electronic auction as described herein. For example, the polar representative may be required in one organization to identify one or more suppliers within the representatives pole to participate in the auction. Under another organization, the polar representatives may be required to assist in qualifying a new, unqualified supplier. Further details regarding particular responsibilities or tasks may be found in this and other applications referred to herein.

A Copy this Auction button 370 allows the author to copy the currently displayed page to create a new auction general information screen. For example, the author may access a previously stored auction screen to use as a basis for creating a new auction screen. A save button 372 allows the author to save the current field entries, and proceed to an auction general information screen.

Referring to FIG. 4, an example of a web page screen 400 displaying tasks for the author after the author has initially scheduled an auction (and before the RFQ is completed and approved). A Preview button 402 allows the author to preview the completed web page (such as the RFQ) before sending it by means of a Send button 404 to suppliers or to individuals within the organization for their review or complete other tasks. A tasks section 403 identifies tasks specific to the particular auction being reviewed, which in the example of FIG. 4, is an RFQ and auction details associated with the auction. A This Task Information section 404 allows the author to determine how to respond after completing a task by selecting either a “Delete this task after submit” button or a “Change Message and Due Date for this Task after submit” button. Under the first option, the author may delete the task after submitting an acknowledgment. The acknowledgment will be sent on behalf of the author as defined in a “From:” section (in this example, Paula Duell).

For example, if the author is to review and complete the RFQ, the author clicks the preview button 402, and if acceptable, may click the Send button 404. In response to clicking the Send button, the system sends or logs a notification regarding the author's completion of the task. For example, by clicking the Send button, the system may open a new e-mail message to be sent to the auction owner to notify the auction owner that the RFQ has been reviewed, and provide any comments in the e-mail. Alternatively, the system may provide an electronic form in a new window (not shown) that allows the author to select one of several options, such as accepting the RFQ without change. After selection one option, the author may click a button within this window that notifies the system that the author has completed the task. Thereafter, the task is deleted from the author's My Tasks section 403 (or section 204).

Alternatively, the user may select the second option to change the message and due date for this task after submitting, and then complete or review a Section field 406, a Message field 408 and a Due Date field 410 (which are similar to the Subject, Additional Comments, and Due Date fields 358, 360 and 362, respectively). Thus, the user may review documents (such as the RFQ) and provide comments to the RFQ author requesting revisions or changes. The user may then add a new task for him or herself, such as reviewing the changed RFQ, in fields 406-410. The user may also modify the Assigned Tasks To section 340 to add an additional task to individuals in the organization, such as the RFQ author to make changes to the RFQ in light of the user's comments. As shown in FIG. 14, an RFQ Author box 412 is provided to permit tasks to be provided to such a person. Likewise, an RFQ Review Team box 414 is provided to assign tasks to such a review team. Further details regarding generating and approving RFQs may be found in U.S. patent application Ser. No. ______, filed ______ entitled “Method and System for Electronic Document Handling, Such as for Requests for Quotations Under an Electronic Auction” (Attorney Docket No. 243768027US).

Expanding upon the above examples, when a Send or Submit button is clicked, the web page form (e.g., RFQ) is submitted to the GCL for approval. In general, the GCL may be required to provide approval for any new auctions as one or his or her tasks. Such approval may be provided as a small application (“applet”) or macro on a submitted RFQ, which the GCL receives (e.g., as via an attachment to an email, via an email notifying the GCL of a posted RFQ and containing a link or path name to access the RFQ stored on the server or local network, or via other means). By accessing the RFQ, the GCL may be required to initially enter a password. After reviewing the RFQ, a dialogue box requests the GCL to choose one of four (or more) options with respect to the RFQ:

1. Approved As-Is, no leverage opportunity within the business

2. Hold RFQ for Additional Leverage Volume from other business units

3. Approved with Amendments or

4. Request Clarifications or Amendments to the RFQ

If the RFQ is approved as-is, the system may automatically send a notification to the RFQ author, and others involved, that the auction may proceed immediately. This task is then logged accordingly by the system, and removed from the GCL's My Tasks section. If the GCL chooses option 2 with respect to the RFQ, then the GCL may be requested to provided a postponement or hold period within a dialogue box (e.g., three months). The system then automatically transmits notification to the RFQ author and others involved in the auction that the auction is to be postponed for the GCL designated hold period. Also, the system disables a counter that would automatically change the status if the GCL did not review the RFQ within N number of days (as described below). However, the system will initiate a new counter to measure how long the Holding for Additional Leverage Volume status remains. The system automatically adds a new task for the GCL to monitor for additional requests for the item to provide additional leverage volume. The due date is set to that of the designated hold period. Under option 3 above, the GCL may amend the RFQ. The system may provide an indication to the RFQ author and others what amendments the GCL made to the RFQ (such as representing RFQ amended text in a different font, color, style, etc.). The system then automatically distributes the RFQ to the RFQ author and other individuals within the organization. The system may automatically assign a new task to the RFQ author to review and approve the GCL's amendments, if the RFQ author has authority for such approval. The system updates the GCL's task list to remove this task thereafter. Alternatively, after GCL approval, the GCL may cause the system to automatically and electronically transmit the RFQ or electronic notification to suppliers, thereby initiating the auction based on GCL approval. The system automatically removes the RFQ review and approval task from the GCL's task list, and assigns a new task to the RFQ author to revise the RFQ in light of the GCL's request. When the GCL selects the Request for Clarification or Amendment status, the system automatically opens a new email message addressed to the author in which the GCL may request whatever clarification or amendment the GCL wishes.

The system automatically provides a GCL approval status or flag to each RFQ, which includes the above four options as status values, as well as two additional status values: Not Yet Submitted for Approval, and Awaiting GCL Review: N Days to Automatic Approval. Under one embodiment, after the RFQ is submitted for review, an applet begins counting down from N number of days from the RFQ Submit date, so that the system may track and determine a number of days until the RFQ is automatically approved. If the GCL fails to review or approve the RFQ within N number of days, then the system automatically changes the status of the RFQ to Approved As-is, No Leverage Opportunity, and updates task lists accordingly.

Of course, many alternatives are possible. For example, the section 403 may be omitted. The system may permit only certain individuals within the organization to assign tasks to other individuals. When the system automatically assigns tasks to individuals, the individual whose actions initiated such automatic tasks (such as the auction owner or author), the system may display a dialogue box for the author that lists the individual to whom a task is to be automatically assigned, a brief described of the subject of the task, a field for the author to provide additional comments, and a default due date, similar to the fields in section 340. The author may then review and modify any of such automatic entries, before clicking an accept button which then causes the system to automatically assign tasks to the appropriate individuals, and notify them of their assigned tasks. In addition to the automatic RFQ approval noted above, the system may provide additional automatic approval of certain tasks. For example, if the auction owner is assigned the task of approving suppliers, and the auction is a Production auction, the system may automatically approve all suggested suppliers if the auction owner has failed to approve suppliers by the schedule due date. Likewise, if the GCL modified the RFQ, and the RFQ author failed to approve or respond to the GCL's amendments by the scheduled due date, the system may automatically prohibit or suspend the RFQ author's ability to modify the RFQ until after the auction is completed. (Thereafter, the RFQ author may modify the RFQ for future auctions if the author wishes to use the previously generated RFQ as a starting point or template for another auction.) As explained below, the system may automatically provide reminders to individuals regarding upcoming tasks. Additionally, the system may automatically establish milestones which correspond to completion of various tasks during an auction's scheduling, setup and execution. Under an alternative embodiment, the system employs metrics about task creation to help monitor and provide feedback regarding the system. For example, time spans between when a task is assigned to an individual in the organization and that task is completed is monitored to help identify inappropriately long time spans for task completion. Likewise, the system may monitor numbers of tasks assigned to various individuals within the organization for work load assessment, which may assist in performance reviews, forecasting hiring needs, and the like. Furthermore, the system may permit individuals to sort tasks by due date, commodity, etc.

While certain user interface techniques are shown and described above, various alternatives are possible. For example, while the Pole Involvement field is shown as separate boxes, this field may employ a drop-down menu. For any date fields, a button or icon may be provided that opens a calendar from which the author may select a desired date. Many other user interface options are available, as though skilled in the relevant art will recognize.

Referring to FIG. 5, an example of a flow diagram illustrating the method of assigning and managing tasks is shown as a method 500. Beginning in block 502, the system provides a home page to a user, including a list of tasks for the user, such as that shown in FIG. 2. In response to appropriate user input, the system, in block 504, provides a new auction information screen, such as that shown in FIG. 3. In block 506, the system receives new auction information from the user, which is stored by the system. Such user input information includes task assignment information, as described herein. In block 508, the system provides any necessary or requested additional screens to the user, such as the screen of FIG. 4. In block 510, the system receives user input to these additional screens. Blocks 508 and 510 may be repeated for any additional screens.

After completing such screens, the system in block 512 distributes the RFQ, auction and other information with appropriate notification for task completion by individuals who have previously been assigned tasks under block 506 (or block 510). For example, the system may distribute an electronic e-mail message to all individuals previously identified in section 340, where the e-mail message provides some basic details about the auction and explains the task to be completed by the e-mail recipient. Alternatively, the system may simply send an e-mail message regarding a new auction, with a hypertext link to one or more electronic documents stored centrally by the system. The recipient of the e-mail may then simple click on the link to access such documents and perform any required task. It yet another embodiment, the system sends no electronic mail messages, but instead simply adds tasks and reminders to calendaring systems associated with the individuals for whom tasks have been assigned. An example of such a calendaring system is Outlook® by Microsoft Corporation of Redmond, Wash. Thus, under this embodiment, the system automatically adds tasks within the Tasks portion of Outlook, and may provide one or more notifications in the Calendar portion of Outlook.

In block 514, the system determines whether the task is complete, and if so, updates the user's or other individual's screens to reflect task completion under block 516. For example, the system either updates tasks section of 204 in FIG. 2 for the user to either delete and remove tasks from the My Tasks section 204, or changes a color or representation of due dates in the due date column 210. In block 518, the system updates any centrally stored and non-personal screens to reflect task completion. For example, under one embodiment, the auction owner, author, and other authorized individuals associated with the auction may view an auction status screen (not shown) that is similar to the My Tasks section 204, but is associated with a single auction, and all individuals within that auction who have tasks to be completed. Thus, the auction owner or other authorized individual may monitor the status of a pending auction to determine whether individuals are timely completing their tasks. The auction owner may, for example, view this list and provide e-mail notification or other messages to individuals to ask them to complete their tasks, if such tasks have not yet been completed.

Under block 520, if a task has not been completed by an individual, the system may provide periodic warning messages to that individual. For example, if a pole representative has seven days to identify one or more suppliers for an auction, but has yet to identify any of such suppliers or otherwise respond to the outstanding task assignment, the system may provide an initial notification four days after the task has been assigned, a second notification six days after the task has been assigned, and a final warning notification the day the task is to be completed. Such notification may be by e-mail, or any known method, including paging, voice messaging, etc. Indeed, notifications provided herein may be accomplished by any method known to those skilled in the relevant art, including wired and wireless methods using any computing or telecommunications devices.

After block 518 or 520, the system continues to execute an electronic auction under a procurement system. For example, the system may complete the assignment and notification of suppliers. Further details regarding assigning and notifying suppliers under an auction system may be found in U.S. patent application Ser. No. ______ filed ______, entitled “Method And System For Identifying And Electronically Communicating With Supplier, Such As Under An Electronic Auction” (Attorney Docket No. 243768037US).

Further details regarding an overall procurement system may be found in U.S. patent application Ser. No. ______, filed ______, entitled “Method and System for Providing International Procurement, Such as Via an Electronic Reverse Auction” (Attorney Docket No. 243768038US).

The system checks for internal consistencies and conflicts between fields completed by the author. For example, if the author set auction duration and completion times that would cause the auction to overlap with a scheduled time and date for a technical review or other task, the system would provide the author with an error message, and request the author to modify either the technical review or auction times. Likewise, while the system automatically inputs certain fields based on links between fields (such as GCL being linked to the commodity), the system will provide error messages to the author when an entered field conflicts with logic in the system for another field to request the author to provide accurate form completion.

Referring to FIG. 6, a block diagram illustrating an example of components of the electronic auction system described above are shown. One or more client or supplier computers 602 and a server computer 604 are interconnected via a public network such as the Internet 606. The computers may include a central processing unit, memory, input devices (e.g., keyboard and pointing devices), output devices (e.g., display devices and printers), and storage devices (e.g., optical and/or magnetic disk drives) all not shown in FIG. 6, but well known to those skilled in the relevant art. The memory and storage devices are computer-readable media that contain computer instructions that implement the auction system. The supplier computers may use a browser to access the web pages via the Internet.

The server computer implements the auction system. The server computer system includes a server engine 608, an auction manager 610, an auction database 612 and an RFQ database 614. The server engine receives requests for resources (e.g., web pages) via the Internet and coordinates the generation and transmission of the resources. The auction manager coordinates the conducting of the auctions. The auction manager stores auction listings and bidding histories in the auction database. When an auction closes, the auction manager supplies the supplier's submitted bids to the individual conducting the auction, and may provide a listing of bids in increasing order of price. The auction database includes an auction table 616 and a bid table 618. The auction table includes an entry for each auction conducted by various buyers within the business organization. The bid table includes an entry for each bid that was placed by a supplier during each auction, with corresponding indicators or links to the appropriate auction in the auction table.

The RFQ database includes one or more electronically generated RFQs 620 (two of which are shown in FIG. 6) and associated electronic attachments 622. While shown in FIG. 6 as stored in the RFQ database of the server computer, attachments (or other documents such as electronic RFQs) may be stored on another computer. The server computer may, of course, store additional documents, such as electronic qualification plans, electronic white papers and other supplier approval documentation, and other electronic documents or forms described herein.

The server computer is also intercoupled with other computers associated with the business organization, such as one or more pole computers 630, GCL computer 632, BSL computers 634, buyer computers 636, e-sourcing team computers 638 and qualification team computers 640. All of such computers are similar to the supplier computers described above. Additionally, such computers may communicate via electronic mail. Thus, the server computer may include an electronic mail component 650 to facilitate electronic communication between such computers. While one server computer is generally shown in FIG. 6, more than one server computer may, of course, be employed, such as a server computer for performing auctions (and thus employing the auction manager and auction database), another server computer for providing electronic mail, purchasing, MRP and/or other functions described herein, and a third Web server computer for handling some or all of the various electronic documents and pages described herein. One server computer may be coupled to the computers 632, 636 and 640 (and possibly other computers) via an intranet or private computer network, while the server computer may in turn be coupled to external server computers and the supplier computers 602 via a public computer network such as the Internet.

While wired connections are shown, the various computers may be connected via wireless connections. The invention can be embodied in a special purpose computer or data processor specifically programmed, configured or constructed to perform one or more of the computer-executable functions described in detail herein. The invention can be practiced and distributed in computing environments where tasks or modules are performed by remote processing devices, which are linked by a communications network. Aspects of the invention described herein may be stored or distributed on computer-readable media, including magnetic, optically readable and removable computer disks, as well as distributed electronically over the Internet or other networks (including wireless networks). Those skilled in the relevant art will recognize that portions of the invention reside on a server computer, while corresponding portions may reside on other computers. Data structures and transmissions of data particular to aspects of the invention are also encompassed within the scope of the invention. Additionally, the term “computer” as generally used herein, refers to any data processing device, including portable computers, palm-top computers, personal digital assistants (PDA), Internet appliances, cellular or mobile telephones, wearable computers, set-top boxes, etc.

One skilled in the art will appreciate that the concepts of the above system can be used in various environments other than the Internet. For example, the concepts can also be used in an electronic mail environment in which electronic mail messages may be used exclusively to assign, report and update tasks, rather than relying on web-based forms for some aspects of the system. Also, various communication channels may be used such as a local area network, wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.). Moreover, the concepts of the present invention may be applied to auctions that are not supported by computer systems or that are only partially supported by computer systems.

Unless the context clearly requires otherwise, throughout the description and the claims, the words “comprise”, “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic task assignment systems, not necessarily for the reverse auction system described above.

The elements and steps of the various embodiments described above can be combined to provide further embodiments. Further details regarding certain aspects of the above-described embodiments, as well as aspects of the overall system may be found in the above U.S. patent applications. All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all electronic commerce systems that operate under the claims to provide a method for procurement. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I (we) claim:

1. In a public computer network connecting a buyer organization and two or more supplier computers each having a browser, wherein the supplier computers are coupled to a set of one or more server computers associated with the buyer organization over the public computer network, a method comprising:
at at least one server computer in the set of server computers, providing an auction information electronic form, wherein the auction information electronic form includes two or more data input fields and a task assignment section, wherein the task assignment section comprises:
individual assignment fields that identify at least first and second individuals in the buyer organization, and
at least first and second task fields that permit a user to assign or modify tasks to the first and second individuals in the buyer organization, respectively, wherein the tasks correspond to tasks to be performed before an auction;
at at least one server computer in the set of server computers, receiving data input provided to the auction form, including input to the two or more data input fields and to the task assignment section, wherein the data input to the task assignment section comprises:
flagging the first and second individuals in the buyer organization for tasks under the individual assignment fields, and
assigning or modifying first and second tasks for the first and second individuals in the buyer organization under the first and second task fields, all respectively;
at at least one server computer in the set of server computers, creating a new reverse auction based on an identified item to procure, wherein the auction is to be conducted at some time in the future;
at at least one server computer in the set of server computers, electronically notifying the first and second individuals in the buyer organization of the new reverse auction and the assigned or modified first and second tasks, respectively; and
at at least one server computer in the set of server computers, receiving input from the first and second individuals in the buyer organization that the respective first and second tasks have been completed.

2. The method of claim 1 wherein the public computer network is the World Wide Web, wherein the browser is a web browser,
wherein the auction form is a web page form stored in a central database coupled to at least one server computer in the set of server computers;
wherein the two or more data input fields of the auction form include a commodity field, a mandatory auction date field, a mandatory auction name field and an auction type field;
wherein the task assignment section comprises first and second due date fields associated respectively with the first and second task fields and having default due dates based on the auction date field, and wherein the individual assignment fields correspond to at least two individuals in the buyer organization selected from a set comprising: an auction owner, a quality assurance individual, a global commodity leader and a pole representative;
wherein the first and second tasks under the first and second task fields correspond to two tasks selected from a task set comprising: approve suppliers to participate in an auction by the auction owner, approve a supplier for participation in the auction by the quality assurance individual, approve the auction by the global commodity leader, and identify at least one supplier in the pole representative's corresponding geographic pole by the pole representative; and
wherein at least one server computer in the set of server computers employs logic to check time spans between a date input to the auction date field and due dates corresponding to the first and second task fields.

3. A system for facilitating procurement of an item under an auction from one of two or more suppliers, the system comprising:
at least one server computer, wherein the server computer is operable:
to provide an auction information electronic form, wherein the auction information electronic form includes at least one data input field and a task assignment section, wherein the task assignment section comprises at least first and second task fields respectively associated with tasks for first and second individuals or organizational positions, wherein at least one of the tasks corresponds to a task to be performed before an auction;
to receive data input provided to the auction information electronic form, including input to the at least one data input field to create a new auction based on an identified item to procure, wherein the auction is to be conducted at a selected time in the future, and wherein the task assignment section identifies first and second tasks for the first and second individuals or organizational positions under the first and second task fields, all respectively; and
to electronically notify the first and second individuals of the first and second tasks, respectively, before the auction.

4. The system of claim 3 wherein a private computer network couples the server computer with a buyer computer, associated with a buyer organization, and the private computer network is coupled, via public computer network, to two or more supplier computers, associated respectively with the two or more suppliers, and wherein the server computer includes a database coupled thereto, wherein the auction form is a display description stored in the database, and wherein the database centrally stores previously completed auction forms for previously conducted auctions for retrieval and modification for a new auction;
wherein the auction information electronic form has at least two mandatory data input fields, wherein the mandatory data input fields include an auction date field, and a commodity field, an auction name field or an auction type field;
wherein the task assignment section comprises:
individual assignment fields that identify at least first and second individuals in the buyer organization, and
first and second due date fields associated respectively with the first and second task fields and having default due dates based on the auction date field; and
wherein the server computer is further operable:
to permit a user to assign new tasks, modify existing tasks or accept default tasks assigned by the server computer with respect to the at least first and second task fields,
to receive input from at least one of the first and second individuals that the respective first or second task has been completed, and
to check time spans between a date input to the auction date field and due dates corresponding to the first and second task fields.

5. The system of claim 3 wherein the server computer is coupled to a database;
wherein the auction information electronic form is a web page form stored in a central database coupled to the server computer;
wherein the task assignment section comprises individual assignment fields and first and second due date fields, wherein the first and second due date fields are associated respectively with the first and second task fields and have default due dates provided by the server computer, and wherein the individual assignment fields correspond to at least two organizational positions selected from a set comprising: an auction owner, a quality assurance individual, a global commodity leader, and a pole representative;
wherein the first and second tasks under the first and second task fields correspond to two tasks selected from a task set comprising: selecting suppliers to participate in an auction, approving a supplier for participation in the auction, approving the auction, and identifying at least one supplier in a geographic pole.

6. The system of claim 3 wherein the server computer is further operable to provide task reminders to the first and second individuals.

7. The system of claim 3 wherein the auction information electronic form comprises two or more mandatory, standard fields, and at least first and second optional comment fields associated with the first and second task fields, respectively.

8. The system of claim 3 wherein the server computer is coupled to a database and wherein the database centrally stores previously completed auction forms to be retrieved and modified for a new auction.

9. The system of claim 3 wherein the auction information electronic form comprises at least two mandatory data input fields, wherein the mandatory data input fields include an auction date field, and a commodity field, an auction name field or an auction type field.

10. The system of claim 3 wherein electronically notifying includes identifying, for review or approval, at least one electronic document in a central library for association with the auction.

11. The system of claim 3 wherein the server computer is further operable to automatically provide approval after a due date passes without the first task being completed.

12. The system of claim 3 wherein electronically notifying includes sending first and second electronic mail messages to the first and second individuals and storing at least one electronic document at a network location, wherein the electronic document may be accessed by a remote computer via a public computer network.

13. The system of claim 3 wherein electronically notifying includes sending first and second electronic mail messages to the first and second individuals.

14. The system of claim 3 wherein the server computer is further operable to permit a user to assign new tasks, modify existing tasks or accept default tasks assigned by the server computer with respect to at least the first and second task fields.

15. The system of claim 3 wherein the server computer is further operable to check time spans between a date of the auction and data input fields in the auction information electronic form.

16. A computer-readable medium whose contents cause a computer system to assist in procuring an item from one of a plurality of suppliers, by:
providing an auction information electronic form, wherein the auction information electronic form includes at least one data input field and a task assignment section, wherein the task assignment section comprises at least first and second task fields respectively associated with tasks for first and second individuals or organizational positions, wherein at least one of the tasks corresponds to a task to be performed before an auction;
receiving information provided to the auction information electronic form, including the mandatory data input field, to create a new auction with respect to the item to procure, wherein the task assignment section identifies first and second tasks for the first and second individuals or organizational positions under the first and second task fields, all respectively; and
before the auction, electronically notifying the first and second individuals of the first and second tasks, respectively.

17. The computer-readable medium of claim 16, further comprising:
providing task reminders to the first and second individuals.

18. The computer-readable medium of claim 16, further comprising permitting a user to assign new tasks, modify existing tasks or accept default tasks with respect to at least the first and second task fields.

19. The computer-readable medium of claim 16 wherein the auction information electronic form comprises at least two mandatory data input fields, wherein the mandatory data input fields include an auction date field, and a commodity field, an auction name field or an auction type field.

20. The computer-readable medium of claim 16 wherein electronically notifying includes identifying, for review or approval, at least one electronic document in a central library for association with the auction.

21. The computer-readable medium of claim 16, further comprising providing automatic approval after a due date passes without the first task being completed.

22. The computer-readable medium of claim 16 wherein electronically notifying includes sending first and second electronic mail messages to the first and second individuals and storing at least one electronic document at a network location, wherein the electronic document may be accessed by a remote computer via a public computer network.

23. The computer-readable medium of claim 16 wherein electronically notifying includes sending first and second electronic mail messages to the first and second individuals.

24. The computer-readable medium of claim 16 wherein the computer-readable medium is a logical node in a computer network receiving the contents.

25. The computer-readable medium of claim 16 wherein the computer-readable medium is a computer-readable disk.

26. The computer-readable medium of claim 16 wherein the computer-readable medium is a data transmission medium transmitting a generated data signal containing the contents.

27. The computer-readable medium of claim 16 wherein the computer-readable medium is a memory of a computer system.

28. A computer-readable medium containing a data structure having information for display and to assist in procuring an item from one of a plurality of suppliers under an auction, the information comprising:
a display description defining an auction information electronic form for creating a new auction with respect to the item to procure, wherein the display description comprises at least first and second mandatory data input portions and a task assignment portion, wherein the first mandatory data input portion corresponds to an auction date field and the second mandatory data input portion corresponds to a commodity field, an auction name field or an auction type field, and wherein the task assignment portion comprises at least first and second task fields respectively associated with tasks for first and second individuals or organizational positions, wherein at least one of the tasks corresponds to a task to be performed before an auction.

29. The computer-readable medium of claim 28 wherein the task assignment portion includes:
individual assignment portions corresponding to individual assignment fields that identify at least the first and second individuals or organizational positions, and
first and second due date portions corresponding respectively to first and second due date fields, wherein the first and second due date fields are associated respectively with the first and second task fields.

30. The computer-readable medium of claim 28 wherein the data structure includes instructions for the display of the information.

31. The computer-readable medium of claim 28 wherein the data structure represents a Web page.

32. The computer-readable medium of claim 28 wherein the data structure represents a document for display.

33. The computer-readable medium of claim 28 wherein the data structure is a data transmission medium transmitting a generated data signal containing the data structure.

34. A system to assist in procuring items from one of a plurality of suppliers, comprising:
means for providing an auction information electronic form, wherein the auction information electronic form includes at least one data input field and a task assignment section, wherein the task assignment section comprises at least first and second task fields respectively associated with tasks for first and second individuals or organizational positions, wherein at least one of the tasks corresponds to a task to be performed before an auction;
means for receiving information provided to the auction information electronic form, including the mandatory data input field, to create a new auction with respect to the item to procure, wherein the task assignment section identifies first and second tasks for the first and second individuals or organizational positions under the first and second task fields, all respectively; and
before the auction, means, coupled to the means for providing and the means for receiving, for electronically notifying the first and second individuals of the first and second tasks, respectively.

35. The system of claim 34, further comprising:
means for permitting a user to assign new tasks, modify existing tasks or accept default tasks with respect to the at least first and second task fields,
means for receiving input from at least one of the first and second individuals that the respective first or second task has been completed, and
means for checking time spans between a date input to the auction date field and due dates corresponding to the first and second task fields.
